(19) United States
(12) Patent Application Publication
(10) Pub. No.: US 2025/0217910 A1
(43) Pub. Date: Jul. 3, 2025

(54) Automatic provisional patent application generator

(71) Applicant: SybarIP, Inc., Tenafly, NJ (US)

(72) Inventor: ophir kretzer-katzir, Tenafly, NJ (US)

(73) Assignee: SybarIP, Inc., Tenafly, NJ (US)

(21) Appl. No.: 18/401,702

(22) Filed: Jan. 1, 2024

(51) Int. Cl. G06Q 50/18

(52) U.S. Cl. CPC G06Q 50/184

(57) ABSTRACT

The present invention introduces an innovative apparatus designed to streamline and automate the process of generating provisional patent applications, particularly addressing the challenges faced in the intersection of Artificial Intelligence and Patent Law. Recognizing the traditional method of creating and submitting patent applications as time-consuming, expensive, and dependent on specialized knowledge of the patent process and prior art, this invention offers a much-needed solution. It specifically addresses the inefficiencies, labor-intensive nature, and high resource demands, including the reliance on patent attorneys, inherent in the current process.

Central to this invention is a fully automated system capable of intelligently comparing unique concepts with all known prior arts registered in patent offices. This is achieved through the integration of advanced AI algorithms. The system, in its preferred embodiment, serves as an automatic provisional patent application generator. It allows users to input their unique concepts, which are then automatically compared against a comprehensive database of prior art. This automation not only significantly reduces the time and cost associated with patent application processes but also ensures a thorough and accurate comparison with existing patents.

The apparatus, therefore, represents a significant advancement in the field of patent application, offering a more efficient, cost-effective, and accessible means for individuals and organizations to secure patent protection for their innovations.

### PRIOR ART

There are a number of examples in the field of technology for Artificial Intelligence and Patent Law. One approach is known as manual patent application. an approach currently used by individuals or companies where they fill out patent applications manually and submit them to the patent office, often requiring the help of patent attorneys, and the process can be time-consuming and costly.

One approach is known as semi-automated patent application. a system where parts of the patent application are automated such as form filling, but still requires significant manual input and review. it does not incorporate ai to compare unique concepts to prior art.

The following publications are believed to represent the current state of the art:

U.S Patent Publication No. US-20220138656-A1 published on May 5, 2022 titled DECISION-MAKING AGENT HAVING HIERARCHICAL STRUCTURE by LE PHAM-TUYEN; RHO CHEOL-KYUN; LEE SEONG-RYEONG; MIN YE-RIN; LE, Pham-Tuyen; LEE, Seong-Ryeong; MIN, Ye-Rin; RHO, Cheol-Kyun Foreign ON Patent Publication No. CN-109583591-A published on Apr. 5, 2019 titled Method and system for simplified knowledge engineering by DOMINIC SELLERS-BLAIS; D Sai Lesi-Bu Laisi

### BACKGROUND OF THE INVENTION

The present invention relates generally to Artificial Intelligence and Patent Law.

### SUMMARY OF THE INVENTION

The present invention seeks to provide An apparatus for generating provisional patent applications.

in the field of Artificial Intelligence and Patent Law, there is a need for The process of generating and submitting a patent application is time-consuming, costly, and requires specialized knowledge about the patent application process and the ability to compare unique concepts to every prior art known in the patent offices. When considering prior arts in that field, there is still a gap providing said solution. The gap the present invention seeks to provide relates to The current process is inefficient, labor-intensive, and requires costly resources such as patent attorneys.

There is a lack of a fully automated system that is intelligent enough to compare unique concepts with every known prior art in the patent offices.

There is thus provided in accordance with a preferred embodiment of the present invention, an automatic provisional patent application generator, uses AI to compare the unique concepts provided by the user to all known prior art in the patent offices. This solution automates the process, making it more efficient and less costly, while also ensuring a thorough comparison to prior art.

### BRIEF DESCRIPTION OF DRAWINGS

The present invention will be understood and appreciated more fully from the following detailed description taken in conjunction with the drawing in which:

FIG. 1 is a simplified illustration of process for An apparatus for generating provisional patent applications. constructed and operative in accordance with a preferred embodiment of the invention:

FIG. 1 is a simplified illustration of process for An apparatus for generating provisional patent applications. constructed and operative in accordance with a preferred embodiment of the invention;

FIG. 2 is a simplified block diagram illustration of another aspect of the use of the system of FIG. 1 for Use Case 1: Startup Company Patent Application

FIG. 3 is a simplified block diagram illustration of another aspect of the use of the system of FIG. 1 for Use Case 2: Independent Inventor Patent Process

FIG. 5 is a simplified block diagram illustration of another aspect of the use of the system of FIG. 1 for Use Case 4: Corporate R&D Patent Application.

### DETAILED DESCRIPTION OF THE INVENTION

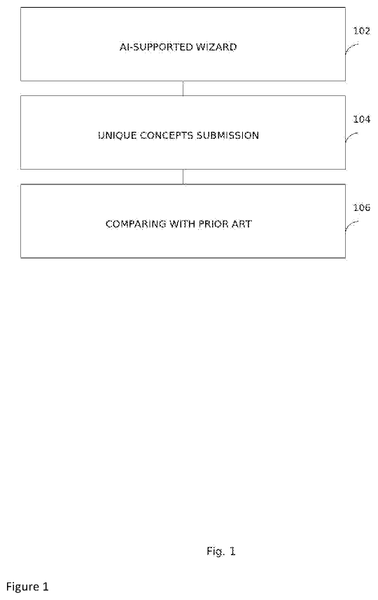

Reference is now made to FIG. 1, which is a simplified block diagram illustration of process for An apparatus for generating provisional patent applications. As shown in FIG. 1, the process includes a Step ((0)) initiates step The AI-supported Wizard guides the overall process. (102), and Step The AI-supported Wizard guides the overall process. (102) assists the user in step The user provides unique concepts in the Unique Concepts Submission phase. (104), and Upon completion of step The user provides unique concepts in the Unique Concepts Submission phase. (104), the concepts are taken to step Submitted unique concepts are compared with prior art. (106) for comparison.

Reference is now made to FIG. 1, which is a simplified block diagram illustration of process for An apparatus for generating provisional patent applications. As shown in FIG. 1, the process includes a The ((0)) initiates the This step involves the usage of an AI-supported wizard to guide the process. (102) to guide the overall process, and The This step involves the usage of an AI-supported wizard to guide the process. (102) assists the user in the Here, the user provides unique concepts for the patent application. (104) phase, where unique concepts are provided, and Upon submission of unique concepts in Here, the user provides unique concepts for the patent application. (104), these are compared with prior art in The unique concepts are compared with every prior art known in the patent offices. (106).

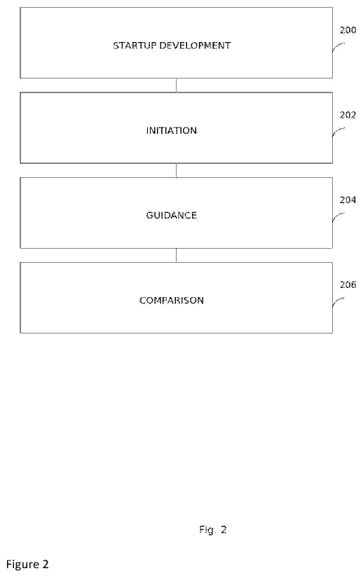

Reference is now made to FIG. 2, which is a simplified block diagram illustration of the system of FIG. 1. As shown in FIG. 2, This embodiment represents a Use Case 1: Startup Company Patent Application.

Accordingly, A startup company has developed a unique technology but lacks the legal expertise to draft a patent. The company uses the Automatic Provisional Patent Application Generator to initiate the AI-supported Wizard, which guides them through the process of submitting the unique concepts of their technology. The system then automatically compares the unique concepts with the prior art to ensure the novelty of the invention.

After the A process that starts when a startup company develops a unique technology but lacks the legal expertise to draft a patent. (200), the company proceeds with the The company uses the Automatic Provisional Patent Application Generator to initiate the AI-supported Wizard. (202), and Upon The company uses the Automatic Provisional Patent Application Generator to initiate the AI-supported Wizard. (202), the The AI-supported Wizard guides the company through the process of submitting the unique concepts of their technology. (204) begins, and After the The AI-supported Wizard guides the company through the process of submitting the unique concepts of their technology. (204), the system performs the The system then automatically compares the unique concepts with the prior art to ensure the novelty of the invention. (206).

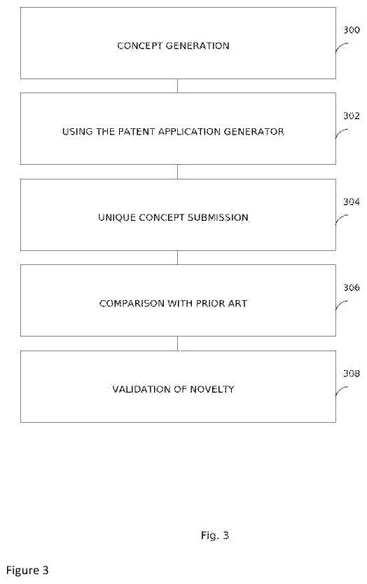

Reference is now made to FIG. 3, which is a simplified block diagram illustration of the system of FIG. 1. As shown in FIG. 3, This embodiment represents a Use Case 2: Independent Inventor Patent Process.

Accordingly, An independent inventor has come up with a unique concept. The inventor uses the Automatic Provisional Patent Application Generator to initiate the AI-supported Wizard, which assists them in the unique concepts submission phase. Upon submission of these unique concepts, the system compares the invention with prior art to ensure it's a novel idea and worthy of a patent.

The unique concept A process that starts with an independent inventor coming up with a unique concept. (300) is then used in the Automatic Provisional Patent Application Generator The inventor uses the Automatic Provisional Patent Application Generator to initiate the AI-supported Wizard. (302), and The Automatic Provisional Patent Application Generator The inventor uses the Automatic Provisional Patent Application Generator to initiate the AI-supported Wizard. (302) assists the inventor in the unique concept submission The AI-supported Wizard assists the inventor in the unique concepts submission phase. (304), and Upon submission of the unique concept The AI-supported Wizard assists the inventor in the unique concepts submission phase. (304), the system compares the invention with prior art Upon submission of these unique concepts, the system compares the invention with prior art. (306), and After comparing with prior art Upon submission of these unique concepts, the system compares the invention with prior art. (306), the system validates the novelty and worthiness of the patent The system ensures the idea is novel and worthy of a patent. (308).

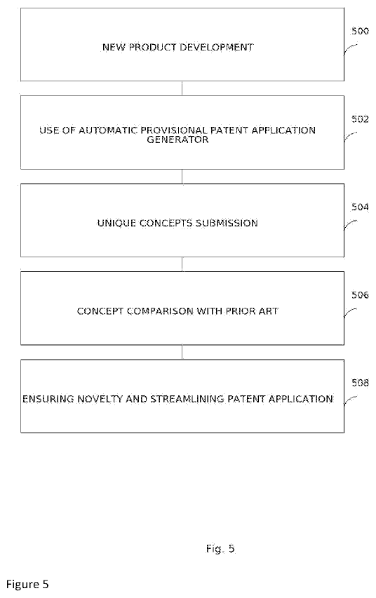

Reference is now made to FIG. 5, which is a simplified block diagram illustration of the system of FIG. 1. As shown in FIG. 5, This embodiment represents a Use Case 4: Corporate R&D Patent Application.

Accordingly, A corporate R&D department developed a new product. They use the Automatic Provisional Patent Application Generator to initiate the AI-supported Wizard, which assists them through the unique concepts submission phase. After the submission, the system automatically compares these concepts with prior art, helping to ensure the novelty of the product and streamline the patent application process.

After A process that begins with a corporate R&D department developing a new product. (500), the R&D department proceeds to The R&D department uses the Automatic Provisional Patent Application Generator to initiate the AI-supported Wizard. (502), and The The R&D department uses the Automatic Provisional Patent Application Generator to initiate the AI-supported Wizard. (502) leads to The AI-supported Wizard assists the R&D department through the unique concepts submission phase. (504), and Following The AI-supported Wizard assists the R&D department through the unique concepts submission phase. (504), the system performs After the submission, the system automatically compares these concepts with prior art. (506), and The After the submission, the system automatically compares these concepts with prior art. (506) aids in This comparison helps to ensure the novelty of the product and streamlines the patent application process. (508).

It will be appreciated by persons skilled in the art that the present invention is not limited by what has been particularly shown and described hereinabove. Rather the scope of the present invention includes both combinations and sub-combinations of the various features described hereinabove as well as modifications thereof which would occur to persons skilled in the art upon reading the foregoing description and which are not in the prior art.

1. A method for generating provisional patent applications, the method comprising:
providing a process that initiates the automatic generation of provisional patent applications;
AI-supported Wizard;
Unique Concepts Submission;
Comparing with Prior Art;
Wherein the said Automatic Provisional Patent Application Generator initiates the said AI-supported Wizard to guide the overall process. the said AI-supported Wizard assists the user in the said Unique Concepts Submission phase, where unique concepts are provided. upon submission of unique concepts in said Unique Concepts Submission, these are compared with prior art in said Comparing with Prior Art.

2. A system comprising a non-transitory, tangible computer-readable medium in which computer program instructions are stored, which instructions, when read by a computer, cause the computer to An apparatus for generating provisional patent applications, the system comprising:
providing a process that initiates the automatic generation of provisional patent applications;
AI-supported Wizard;
Unique Concepts Submission;
Comparing with Prior Art;
Wherein the said Automatic Provisional Patent Application Generator initiates the said AI-supported Wizard to guide the overall process. the said AI-supported Wizard assists the user in the said Unique Concepts Submission phase, where unique concepts are provided. upon submission of unique concepts in said Unique Concepts Submission, these are compared with prior art in said Comparing with Prior Art.
